(19) United States
(12) Patent Application Publication
(10) Pub. No.: US 2021/0353113 A1
(43) Pub. Date: Nov. 18, 2021

(54) INTEGRAL BODY DRYER

(71) Applicant: BODY DRYER, S.L., MADRID (ES)

(72) Inventor: Guillermo SORIA SANTOS, MADRID (ES)

(21) Appl. No.: 17/286,520

(22) PCT Filed: Oct. 25, 2019
(86) PCT No.: PCT/ES2019/070723

§ 371 Date: Apr. 19, 2021

(30) Foreign Application Priority Data
Oct. 25, 2018 (ES) P201831035

(51) Int. Cl. A47K 10/48; F26B 3/04; A45D 20/14

(52) U.S. Cl. CPC A47K 10/48; A45D 20/14; F26B 3/04

(57) ABSTRACT

The present invention describes an integral body dryer that includes a diffuser and a protective cover attached to an upper end of a support column, wherein the diffuser contains a turbine, an electrical resistor and a pipe with a nozzle for the outlet of air, and the column comprises a rail for sliding the diffuser, the diffuser being able to move along the length of the column in a manner selected from electrical or manual, to blow air along the column and thus dry a user

### OBJECT OF THE INVENTION

The present invention, as expressed in the title of this specification, relates to a body dryer. The device has been designed with the intention of (i) achieving an effective as well as easy drying of the entire body, (ii) reducing the drying time to keep it around one minute, and (iii) eliminating the need for continuous washing of towels and the like in order to avoid the consequent negative environmental impact that it entails.

To this end, the body dryer has a diffuser to blow air, which is heated by means of a resistor, which is able to move along the length of a vertical column sweeping the body of the user along the entire height thereof. The user must only rotate horizontally so that the blown air can reach all areas of their body.

The invention has particular application in the industry field of hygiene devices for drying the body by means of hot air.

### Technical Problem to be Solved and Background of the Invention

In the current state of the art, numerous pressurised air devices are known for drying both hands and hair and even other portions of the body. These dryers have evolved in power and efficiency, even targeting not only portions of the body, but also the entire body, in an integral manner.

The evolution of these dryers is mainly geared to savings in places of public use due to the volume of towels required, whether they are textile or made of paper and, furthermore, to an awareness of the environmental impact caused by these products, either at the waste level or by the use of detergents and the amount of water necessary for washing.

Thus, the use of hand dryers has been widely implemented for long enough for the different public or community-use premises, such as may be, among others, hospitals, gyms, shopping centres, petrol stations, schools or companies, to make the decision about whether to implement air dryers, textile or paper towels for drying hands.

The evolution of the few body dryers that exist in the state of the art is mainly geared (i) to preventing the negative environmental impact that the continuous washing of towels entails (excessive use of water and detergents), (ii) to the economic savings entailed by air drying by comparison to towel drying (replacement of towels, labour and electricity) and, (iii) to the convenience and speed of drying. This last section, being a fundamental aspect when drying, has not been achieved by any of the existing body dryers on the market.

Regarding the integral body dryers, in sports facilities one of the modalities is for the user to bring their own towel to dry off. Inevitably, this causes a series of drawbacks to the user who must accept them, such as:
the weight of the towel in the sports bag,
the space it occupies,
the need to wash the towel at home, and
the humidity coming off of the towel to the rest of the garments, causing a bad smell and a possible deterioration of the other garments.

In another type of sports facilities, towels are provided to users, which means great comfort, by eliminating the aforementioned drawbacks. However, convenience for users becomes a major drawback for the centre, due to the following effects:
the need for more storage space, the amount of water needed to wash the towels,
the use of detergents that pollute the environment,
increased labour for washing and ironing,
the need for a large inventory capable of supplying all users, with the consequent acquisition and replacement cost, and
the need to hire a company dedicated to the replacement of towels.

These same problems that arise in sports facilities can be transferred to hotels and the like, hospitals, nursing homes, sports centres, spas and any other type of public assistance centre.

It is also important to mention that drying by means of towels or any of the variants thereof is more harmful to the skin than air drying. It further requires more time and effort to dry all portions of the body.

With reference to the object of the present invention, integral body dryers are also known in the state of the art.

An example is represented in patent document ES1103806U. This document describes an arc formed by a hollow tube with a multitude of evenly distributed orifices through which pressurised air supplied by a compressor comes out. The arch has standard dimensions so that a user can place themself inside it without problems, so most users must approach one side or the other of the arch columns to receive the air depending on which areas of the body.

However, despite the fact that this device exhibits a fairly viable solution in terms of uniform drying of the body, it exhibits a problem regarding the size of the structure, that does not enable much flexibility in the movement or in terms of the location thereof, being focussed on being placed in the frame of a door, preferably at the exit of a shower area. Furthermore, drying some of the more covered portions of the body seems complicated.

Another example is represented in patent document DE19504605A1, wherein a device made up of a fixed frame is described that includes articulated arms that have the possibility of turning to get more or less close to the body of the user. A series of nozzles are placed for the outlet of air on the ends of each one of the two arms. The nozzles have a rectangular-shaped opening and are covered by a rotatable adapter that includes an also rectangular-shaped air opening. Thus, the intensity of the air is adjusted by turning the adapters, so that the rectangular opening thereof more or less coincides with the rectangular opening of the nozzle. However, this invention also exhibits a number of problems as described below.

First, the device has a structural configuration that, although it makes it portable, to be able to be placed in any position, it is not able to be placed, for example, at the exit of a shower tray or a changing room, by way of a door.

Furthermore, having so many joints implies a high loss of air pressure. Due to the fact that body drying is carried out, to a greater extent, by means of displacing the liquid and not by means of evaporation, these pressure losses would imply a drawback for the drying of the body. Nothing is stated in the invention about the generation of pressurised air, but obviously it must be placed as an accessory to the device, by way of a motor, for which ample additional space is needed.

Furthermore, it exhibits the drawback that the outlet of air is not especially focussed on the immediate drying of the user. The invention indicates that the device is more focussed on therapeutic use or comfort due to the reception of temperature-controller air than on the usual and daily drying use of a user, wherein drying time and efficiency are paramount. This is stated in the description when describing that, in one embodiment, the device includes three air nozzles for each column, which makes it practically impossible to quickly dry the entire body and it is impossible for air to access the entire body.

Another example is represented in patent document ES2620687A1 by means of an integral body dryer that has a structure made up of two columns, a fixed one solidly attached to a fixed compressor by means of a fixed rigid pipe, and a movable one, solidly attached to a movable compressor by means of a movable rigid pipe capable of moving along a rail. The columns have oblong openings placed in alignment along the entire length of the respective columns, so that the outgoing air can access the entire body of the user.

This device, despite highly-effectively covering practically the entire body to be dried, also enables the air outlets to be brought closer for a more effective drying. However, it is once again a body drying solution that exhibits problems with the size of the structure, requiring an important installation and space.

The present invention solves these problems, which are not solved in the current state of the art, by means of a dryer that includes a diffuser, with the ability to move along the length of a column, that houses all the components necessary to carry out the drying of the body of a user, reducing energy losses to a minimum, which translates into excellent air power in terms of pressure and temperature.

### SUMMARY OF THE INVENTION

The present invention relates to an integral body dryer intended to be able to dry a user in a time not exceeding that used by means of a towel and occupying a reduced space. The dryer comprises a device formed by means of a diffuser, that is able to move along the length of a column, and an optional protective cover that is attached to the column.

The diffuser houses the fundamental elements that participate in the drying process, such as a turbine, an electrical resistor and a pipe with a nozzle for the outlet of air. Furthermore, the diffuser is able to slide along rails placed in the column along which it moves. To this end, the diffuser can include attachments to be placed on a platform with guides that fit on the rails or directly include guides for the attachment thereof on the rails of the column. The different configurations of guides and rails are those known in the state of the art, being able to even be a single guide or several rails.

Thus, sliding the diffuser along the rail implies the movement of the dryer along the length of the column, which will have a length greater than the height of a user, so that the air coming out through the nozzle is able to sweep the body of a user over the entire height thereof.

With this configuration, a user can move the diffuser along the length of the column so that the nozzle blows air over all portions of their body simply by positioning themself in front of the nozzle, turning horizontally to encompass all areas of their body.

Furthermore, the dryer of the invention can include a protective cover that can be independent but is preferably attached to the column. The cover can also be considered to be removable. The intention of including the cover is due to the fact that, preferably, the dryer is placed next to a shower, so that once the shower is finished, a user is ready to dry practically without having to move. On standby, the diffuser is placed inside the protective cover with the intention of isolating it from possible splashes of water that could enter therein. As indicated, the protective cover can be independent, so that it is placed on the diffuser once its use has been completed, by way of a helmet. This arrangement is not the preferred one, since it can cause not only the loss of the cover but the placement of it on the diffuser after it has been used to be forgotten. However, as it is placed attached to the column, the diffuser will always be able to be positioned inside the protective cover at the end of a use.

The dryer of the invention, configured as described, can be separated from the column in order to be manually used and to be able to focus the outlet of air on an area of the body that is more difficult to access or needs more air flow, depending on the user's interest. Once used, it is returned to the position thereof so that the electronic management of the movement according to the selected program continues.

With the power of the turbine and the focus of the design being on achieving the minimum energy losses, the air is capable of reaching a distance greater than 25 cm with sufficient speed and pressure to carry out the drying of the body of the user which, in addition to drying the water droplets by means of evaporation, further changes their location, facilitating the elimination thereof. In any case, for a more effective drying, the user should be preferably positioned at a distance between 10 and 15 cm from the nozzle of the diffuser.

Moreover, the movement of the diffuser along the rails of the column can be carried out both electronically, by means of selecting a program, and manually, acting directly on the moving diffuser, so that the dryer may not only be stopped to concentrate the outlet of air in a particular area, but also moved to control the position more precisely. Once the manual drying is finished, the diffuser is returned to the position thereof in the column to be controlled again by the selected electronic program and, once the drying is finished, be returned to the rest position thereof inside the protective cover.

The electrical activation of the movement of the diffuser along the length of the column can be carried out by means of selecting a program on a control panel by means of which the desired parameters are selected to choose from the speed of movement of the diffuser, the path or the operating time, for example, in addition to being able to further select parameters such as, for example, air temperature or air outlet power.

Furthermore, the dryer is extremely versatile, the diffuser being able to be removed from the column to be manually used and thus concentrate the outlet of air in a determined area of the body to reposition it on the column once the manual movement is finished.

This autonomy of use enables the dryer to focus on the use thereof by people with mobility problems, so that they can be dried without the need for help from third parties.

Even in situations wherein it is not feasible to remove the diffuser from the column, a possibility to provide autonomy to people with reduced mobility may consist of placing them in a motorised device, such as a chair or the like, that enables the user to rotate horizontally. Thus, the combination of the vertical movement of the diffuser with the rotation of the user, would enable the drying to be carried out completely.

Additionally, it also facilitates the use in drying animals, so that it can be held with both hands while the dryer is moved along the body or it can even be rubbed to facilitate drying in the case of long-haired animals.

The dryer can also be placed inside a covering that extends over the entire length of the column. The covering includes a longitudinal opening wherein the nozzle of the diffuser is coupled, so that all the air in the nozzle comes out to the outside of the covering. To this end, the nozzle preferably has an elongated shape and aligned with the longitudinal axis of the diffuser. Thus, the groove can have the smallest dimension with the same effectiveness of the diffuser.

### BRIEF DESCRIPTION OF THE FIGURES

To complement the description that is being made and for the purpose of helping to better understand the features of the invention, according to a preferred practical exemplary embodiment thereof, a set of drawings is attached wherein, for illustrative and non-limiting purposes, the following figures have been represented:

FIG. 1 represents a front view of the diffuser used by the drying device of the invention located on a column wherein there is also a protective cover.

FIG. 2 represents a side view of the diffuser of FIG. 1.

FIG. 3 represents a front view of the diffuser located inside a covering that includes a groove wherein the nozzle is coupled.

FIG. 4 represents a cross-sectional side view of the configuration represented in FIG. 3 to see the inner arrangement of the diffuser.

Below is a list of the references used in the figures:
1. Diffuser.
2. Nozzle.
3. Column.
4. Rail.
5. Electrical resistor.
6. Protective cover.
7. Groove.
8. Covering.

### DESCRIPTION OF A PREFERRED EMBODIMENT

The present invention relates to an integral body dryer. It is made up of a device that includes a diffuser (1) that includes guides for sliding along a rail (4) placed on a column (3) and an optional protective cover (6), the function of which is to house the diffuser (1) when it is not being used to prevent foreign elements from entering, such as dust and, particularly, water when placed in proximity to a shower.

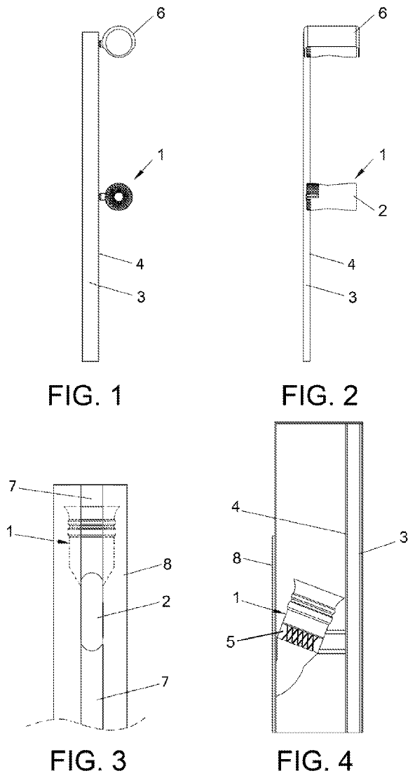

The diffuser (1) and the protective cover (6) installed on the column (3) are represented in FIGS. 1 and 2.

In order to avoid power losses, the diffuser (1) has a cylindrical-shaped configuration, the air entering through one of the bases and leaving through the other base, so that the air path is as simple as possible, with the focus on minimal power loss due to the movement of air.

The diffuser (1) is made up of a turbine, not represented in the figures, internally placed at one end and responsible for taking in the air that is going to be propelled to provide drying, an electrical resistor (5) responsible for heating the air, and a nozzle (2), placed at the other end of the diffuser (1). Preferably, the nozzle (2) incorporates a grid with two objectives: guiding the air, so that noise is eliminated, and protection for preventing the entry of foreign elements that could get stuck, obstructing the outlet of air.

The movement of the diffuser (1) along the length of the column (3) enables the nozzle (2) to be placed at the height of all portions of the body of the user to be dried, being able to blow air and carry out drying without any problem.

An object of the present invention is for the diffuser (1) that moves to dry the body to be configured so that it incorporates all the elements necessary for drying, such as the pressurised air generator, in other words, the turbine, the air heater, in other words, the electrical resistor (5) and the pipe incorporating the air outlet nozzle (2) itself. This implies that there are no energy losses due to the circulation of air due to the fact of having the turbine displaced from the pipe or due to the length of the pipe. This translates into minimal power losses in the device that enable the outlet air coming through the nozzle (2) to not only be adequate in terms of speed and pressure, but also due to these minimal losses, the effectiveness to be greater. Moreover, the electrical resistor (5) has sufficient capacity to heat the entire air flow that passes through the diffuser (1) at the temperature considered adequate and that can be adjusted by the user or be defined.

The configuration of the device implies that the air outlet power coming through the nozzle (2) is sufficient to be able to carry out the drying of the body in less time than that used with a towel.

The width of the nozzle (2) is considerably less than that of a person's torso, so that the volume it occupies is not detrimental in terms of the space necessary for the placement thereof, being preferred that the user must move horizontally so that the air falls on all portions of their body.

Regarding the movement of the device along the column, it must be noted that it can be manual or electric. Thus, the device can move around the column (3) electrically, so that the movement speed, the path and the operating time can be programmed. To this end, the user can select a program that provides a very slow device speed, so that drying is carried out by horizontal sections while rotating so that the air reaches all portions of their body. In another mode, a faster speed can be selected, so that the device dries the body by vertical sections despite having to move vertically several times. Moreover, when used for drying animals, for example, the path can be selected so that air is not blown into unnecessary areas where there is nothing to dry. The operating time is also important, there being cases where there is no rush to finish drying and a longer operating time is preferred.

To activate the movement of the diffuser (1) electrically, the dryer of the invention can incorporate an electronic panel wherein the operating parameters can be selected, such as movement speed, the path or the operating time. Furthermore, other parameters may also be selected, such as, for example, air temperature or air outlet power. This panel can be in the same diffuser (1) or external thereto.

Furthermore, the diffuser (1) can further be moved through the column (3) manually, driven by the user themself, so that they are able to position the diffuser (1) along the rail (4), stopping it and moving it at their convenience to select which portions of the body are considered to need more air flow for drying. To be able to move it manually, the electric release of the diffuser (1) can be carried out, for example, by simply stopping the diffuser (1) or by pressing a button that locks the device and keeps it attached to the column (3). This manual release and use is only temporary so, after a certain time, the control of the diffuser (1) is electric again.

When drying is finished, the program has an option to ensure that the diffuser (1) moves to the upper end of the column (3) to be housed inside a protective cover (6) that protects it from foreign elements such as dust or water that may affect the operation thereof. In the case of having been activated manually, this activation is temporary, so that after a time has passed the electric control of the diffuser is turned back on (1).

The protective cover (6), in turn, is attached to the column (3) at the upper end in a predetermined position with respect to the rail (4), so that the diffuser (1) is placed inside the cover (6) when moving to the end of the rail (4).

Furthermore, it must be considered that the diffuser (1) can be disassembled from the column (3). This fact is related to the possibility of personalised use of the diffuser, wherein the user may need to focus the air outlet towards more inaccessible areas for the diffuser (1) being placed in the column (3) to achieve a more effective drying. Once this drying is finished, the diffuser (1) is returned to the position thereof in the column (3) to be electrically controlled again. Thus, it can be seen that the versatility of the integral body dryer of the present invention is complete, the diffuser (1) even being able to be removed from the column (3)

For its part, the rail (4), despite being considered in the singular, it can also relate to several rails (4), just by adapting the configuration of the guides. In fact, in a preferred embodiment the column (3) incorporates rails (4) wherein a platform with guides is placed to slide along the rails (4), while the diffuser (1) incorporates attachments to be attached to the platform, thus facilitating the disassembly of the diffuser (1) from the column (3). In any case, the configuration of the guides and rails (4) is as wide as can be conceived and of those known in the state of the art.

In a second embodiment, as represented in FIGS. 3 and 4, along the entire column (3) there is a covering (8) housing the rails (4) and, therefore, leaving the diffuser (1) enclosed. However, this covering (8) is not completely closed, Instead, it incorporates a groove (7) on the front face facing the column (3) and the rails (4), in other words, the outlet nozzle (2) of the diffuser (1) for the outlet of air. Thus, the diffuser (1) is attached at the rear area to the rails (4) of the column (3) and has the nozzle (2) adapted to the groove (7). Preferably, the nozzle (2) has an elongated configuration and is placed vertically, with the longitudinal axis aligned with the longitudinal axis of the diffuser (1), in order not to have a very wide groove (7) in the covering (8), but rather to be of the smallest possible dimension without affecting the efficiency of the diffuser (1). Furthermore, the air outlet nozzle (2) is aligned with the air inlet mouth in the diffuser (1), so that pressure losses are minimal. To this end, in order for the covering (8) to not have a cross section with dimensions that are too large for it to house the entire length of the diffuser (1), the diffuser is placed on the rails (4) of the column (3) with a certain inclination, as desired. This inclination can be combined with an inclination in the nozzle itself (2), a small pressure loss being acceptable. Thus, a compromise is reached in the position of the diffuser (1) wherein the inlet of air through the turbine, not being in a horizontal position, and the outlet through the nozzle (2), as it is not rotated 90 degrees, are favoured. The covering (8) can also incorporate the protective cover (6).

Lastly, it should be noted that the present invention should not be limited to the embodiment described herein. Other configurations can be made by those persons skilled in the art in light of the present description. Accordingly, the scope of the invention is defined by the following claims.

1. An integral body dryer comprising a diffuser and a support column;
the diffuser comprises a turbine, an electrical resistor and a pipe with a nozzle for the outlet of air, housed inside, and
the column comprises a rail for sliding the diffuser,
wherein the diffuser is able to move along the length of the column in a manner selected from electrical or manual, to blow air along the column and thus dry the body of a user in the entirety thereof.

2. The integral body dryer, according to claim 1, wherein a protective cover is attached to an upper end of the column.

3. The integral body dryer, according to claim 1, including a covering, which incorporates a longitudinal groove, which houses the column, the diffuser being inside the covering.

4. The integral body dryer, according to claim 3, wherein the nozzle is positioned in the groove so that all the air it expels comes out of the covering.

5. The integral body dryer, according to claim 4, wherein the nozzle has a substantially rectangular configuration and is longitudinally placed, according to the axial direction of the diffuser, to be oriented according to the groove of the covering and the groove to have the smallest dimension with the same effectiveness of the diffuser.

6. The integral body dryer, according to claim 1, including a control panel for the electrical activation of the movement of the diffuser along the length of the column by means of selecting a program.

7. The integral body dryer, according to claim 6, wherein the program selects movement parameters of the diffuser to select from speed, path, operating time and a combination of some of them and also parameters related to the outlet air to select from temperature, power and a combination thereof.

8. The integral body dryer, according to 6, wherein the program can be temporarily interrupted for manual control of the movement of the diffuser.

9. The integral body dryer, according to claim 6 wherein the program ends with the introduction of the diffuser in the protective cover.

10. The integral body dryer, according to claim 1, wherein the diffuser comprises an attachment element for coupling to a platform located on the column configured for sliding along the rail.

11. The integral body dryer, according to claim 1, wherein the diffuser comprises a guide configured for coupling to the rail (4) and to be able to slide along the column.

12. The integral body dryer, according to claim 8, wherein the diffuser is removable from the column to be manually used.
